(19) United States
(12) Patent Application Publication
(10) Pub. No.: US 2025/0257765 A1
(43) Pub. Date: Aug. 14, 2025

(54) CONSTANT VELOCITY JOINT AND ASSEMBLY THEREWITH

(71) Applicant: Steering Solutions IP Holding Corporation, Saginaw, MI (US)

(72) Inventors: Eduardo R. Mondragon-Parra, Freeland, MI (US); Jeffrey R. Courville, Frankenmuth, MI (US); Robert G. Paquette, Saginaw, MI (US)

(21) Appl. No.: 19/048,185

(22) Filed: Feb. 7, 2025

Related U.S. Application Data
(60) Provisional application No. 63/551,419, filed on Feb. 8, 2024.

(51) Int. Cl. F16D 1/04; F16D 3/16

(52) U.S. Cl. CPC F16D 1/04; F16D 3/16

(57) ABSTRACT

A constant velocity joint includes a first housing part having a pivotal bearing part and second housing part having a connection part, the connection part having an opening extending along a rotational axis of the first and second housing parts and having a splined face extending along a plane substantially transverse relation to the rotational axis, wherein the splined face has teeth extending from a radial inner diameter to a radial outer diameter, wherein the teeth are not the widest at the radial outer diameter.

### CROSS-REFERENCE TO RELATED APPLICATIONS

This application claims the benefit of U.S. Provisional Application Ser. No. 63/551,419, filed Feb. 8, 2024, which is incorporated herein by reference in its entirety.

### FIELD OF THE INVENTION

The present disclosure generally relates to intermediate shaft assemblies for motor vehicles, and more specifically, to an intermediate shaft assembly for a vehicle having coaxial shafts connected to one another.

### BACKGROUND OF THE INVENTION

Shaft assemblies, such as a wheel hub first member and constant velocity joint second member, are brought into clamped relation with one another to prevent relative rotation between the first and second members. It is desired to minimize torsional stress at an interface between the first and second member. It is also desired to minimize the surface area of the interface, thereby minimizing the space requirements therefor. Further, it is desired to distribute stress loads across the interface to minimize stress loads at any single location.

### SUMMARY OF THE INVENTION

It is an object of the present disclosure to provide a constant velocity joint that overcomes at least some of the drawbacks discussed above.

It is a further object of the present disclosure to improve upon the construction and performance of an interface between first and second members, including a constant velocity joint and another member, such as a wheel hub.

In accordance with an aspect of the disclosure, a constant velocity joint includes a first housing part having a pivotal bearing part and second housing part having a connection part, the connection part having an opening extending along a rotational axis of the first and second housing parts and having a splined face extending along a plane substantially transverse relation to the rotational axis, wherein the splined face has teeth extending from a radial inner diameter to a radial outer diameter, wherein the teeth are not the widest at the radial outer diameter.

In accordance with another aspect of the disclosure, a constant velocity joint is provided including a housing having a first housing portion having a pivotal bearing part and second housing portion having a connection part. The connection part has a splined face extending along a plane substantially transverse relation to the rotational axis, wherein the splined face has teeth extending from a radial inner extent to a radial outer extent. The teeth are widest at a location spaced radially from the radial inner extent and the radial outer extent.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a cross-sectional view taken generally along a central axis of rotation of a wheel hub and universal joint assembly constructed in accordance with one aspect of the disclosure;

FIG. 2 is a schematic illustration of a plurality of planes of a splined face tooth in accordance with an aspect of the disclosure;

FIG. 3 is a fragmentary schematic view looking transversely to plane B of FIG. 2 of a plurality of teeth of a splined face of a universal joint in accordance with an aspect of the disclosure;

FIG. 4A is a view similar to FIG. 3;

FIG. 4B is a view similar to FIG. 4A looking transversely to plane B′ of FIG. 2;

FIG. 4C is a view similar to FIG. 4A looking transversely to plane B″ of FIG. 2; and

FIGS. 5A and 5B illustrate a tooth geometry of a splined face of a universal joint in accordance with an aspect of the disclosure; and

FIGS. 6A and 6B illustrate a tooth geometry in accordance with the prior art.

### DETAILED DESCRIPTION

Referring now to the Figures, where the invention will be described with reference to specific embodiments, without limiting same, it is to be understood that the disclosed embodiments are merely illustrative of the non-limiting embodiments of the invention that is embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

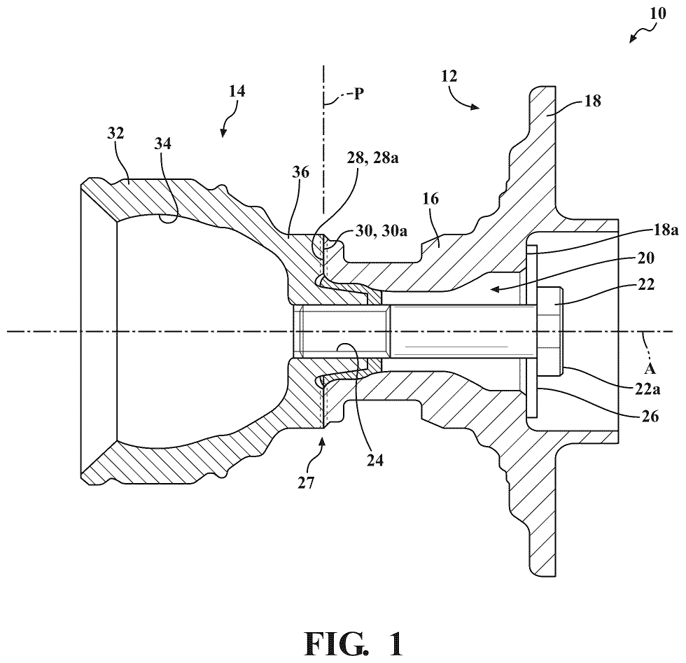

Referring to FIG. 1, a cross-sectional view taken generally along a central axis A of rotation of a first member, shown as a wheel hub, and a second member, shown as a universal joint, with the combination of the first member and the second member referred to as constant velocity joint and wheel hub assembly, or assembly 10, constructed and assembled in accordance with the disclosure is shown. The assembly 10 includes a wheel hub 12 and a constant velocity joint (CVJ) 14, also referred to as universal joint. The wheel hub 12 comprises a sleeve portion 16 and a wheel flange 18, with the wheel flange 18 extending radially outwardly from both the central axis A and the sleeve portion 16 for bolting a wheel disc of a wheel (not illustrated) to the wheel flange 18. The sleeve portion 16 has a through opening 20 through which a clamping element 22, shown as a threaded bolt, by way of example and without limitation, extends for axially clamping the wheel hub 12 to the CVJ 14. A threaded end of the clamping element 22 is threaded in a female threaded opening 24 of the CVJ 14, and a flange, such as can be provided by a washer 26, by way of example and without limitation, is engaged and compressed by an enlarged head 22a of the clamping element 22 and a shoulder 18a of wheel flange 18 as the clamping element 22 is tightened during assembly, thereby drawing the wheel hub 12 and the CVJ 14 axially toward one another, thereby axially clamping the wheel hub 12 to the CVJ 14.

The CVJ 14 has a housing including a first housing part, also referred to as first housing portion or ball track housing part, shown as an inboard housing part 32, by way of example and without limitation, with one or more outer ball tracks 34 provided for rolling receipt of balls (not shown) therein to allow pivotal movement of CVJ 14 relative to another shaft (not shown), as is known, and a second housing part, also referred to as second housing portion or connection housing part, shown as an outboard housing part 36, by way of example and without limitation. The outboard housing part 36 provides the female threaded opening 24, which faces the wheel hub 12, extending along the rotational axis A of the first and second housing parts 32, 36 and which is threadingly engaged by the clamping element 22 for drawing wheel hub 12 and CVJ 14 into clamped engagement with one another. Accordingly, first housing part 32 forms a pivotal bearing part via ball tracks 34 and balls disposed therein and second housing part 36 forms a connection part for fixed attachment to another member, such as wheel hub 12. It is to be understood that the CVJ 14, although discussed as being fixed to wheel hub 12, could be used in a different application, such as at an opposite end of a half shaft, by way of example and without limitation, as would be understood by a person possessing ordinary skill in the art of universal joints upon viewing the entirety of the disclosure herein.

The assembly 10, to facilitate transmitting torque about the central axis A between the wheel hub 12 and the CVJ 14, has an outboard face spline interface 27 formed by interdigitated first and second toothings, also referred to as a first splined face 28 of the wheel hub 12 and a second splined face 30 of the CVJ 14. The first and second splined faces 28, 30 extend radially in transverse or substantially transverse (substantially is intended to mean that the relation may be less than purely transverse, such as by about greater than 0 to 5 degrees) relation to the central axis A along a plane P about at least a portion of wheel hub 12 and CVJ 14, respectively, and preferably about the entirety of the annular faces of the wheel hub 12 and CVJ 14. Accordingly, the first splined face 28 and the second splined face 30 preferably extend annularly in circumferentially continuous fashion in symmetrical relation about the central axis A and in interdigitated relation with one another along plane P.

The first splined face 28 is defined by a plurality of first teeth 28a extending radially in generally transverse relation relative to the central axis A and the second splined face 30 is defined by a plurality of second teeth 30a extending radially in generally transverse relation relative to the central axis A, wherein the first teeth 28a are interdigitated with the second teeth 30a to prevent relative rotation between the wheel hub 12 and the CVJ 14. Accordingly, as is known with interdigitate teeth of this fashion and orientation, peaks of the first teeth 28a and the peaks of the second teeth 30a extend axially beyond one another into respective valleys, also referred to as roots, relative to central axis A.

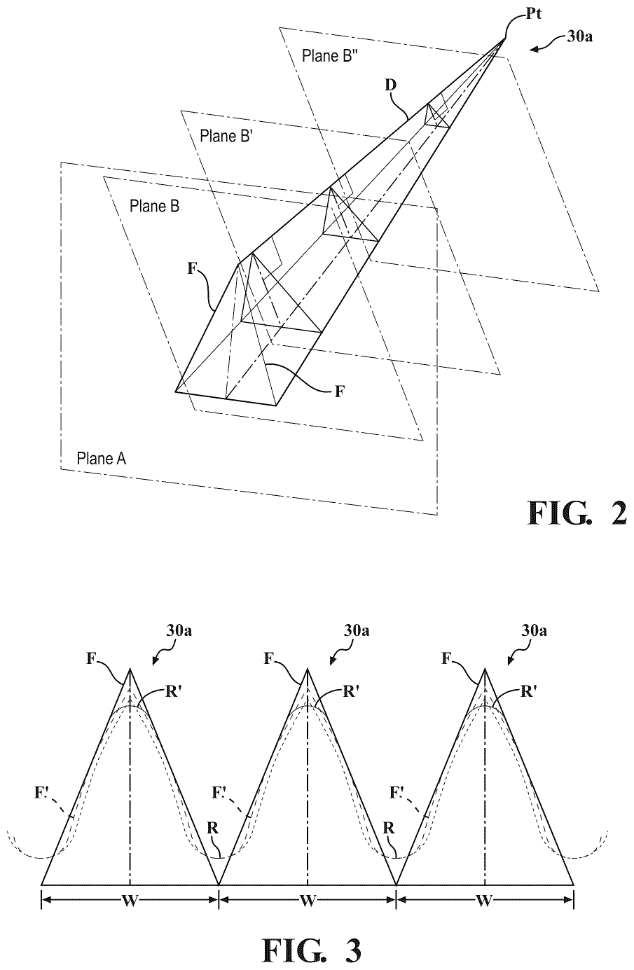

At least one of the first teeth 28a and the second teeth 30a geometry, and in one non-limiting embodiment, the second teeth 30a, is contoured such that a width W of the second teeth 30a are not their widest at a radial outermost extent from the central axis A, wherein the radial outer extent can be a radial outer diameter, further away from the central axis A in comparison to a radial inner extent of the second teeth 30a. In one non-limiting embodiment, the second teeth 30a are widest at a location between the radial innermost extent, also referred to as innermost diameter, and the radial outermost extent, also referred to as outermost diameter. Accordingly, the second teeth 30a are widest at an intermediate location spaced radially from the radial inner extent and the radial outer extent, wherein the widest location can be midway or approximately midway between the radial inner extent and the radial outer extent, by way of example and without limitation. Further yet, each second tooth 30a is not defined by linearly straight, flat, also referred to as planar faced radially extending segments, such as shown in FIGS. 6A and 6B, but rather, each second tooth 30a is defined by connecting a series of 2D geometries defined on multiple planes, shown in FIG. 2 as planes B, B′, B″. The connection between the 2D geometries can be accomplished by splines (continuous curve having a continuously varying width, also referred to as thickness) and the 2D geometries can be 2nd order curves (e.g. circles, ellipses) or higher order (e.g. polynomials) or functions with transcendent terms (e.g. cycloids, involutes).

In FIG. 2, plane A indicates the radial outside (radially outermost diameter surface) of the second tooth 30a. The geometry ultimately converges to a single locus or point Pt. The axis of rotation A is not indicated. The series of radially spaced, parallel planes B, B′, B″ are normal or perpendicular to a directrix D. FIG. 2 only shows the three (3) planes B, B′, B″ for clarity of visualization, but could be an infinite number of planes. The minimum number of planes is 3, and the maximum number is defined by the desired resolution in the geometry definition and may approach infinite as the resolution is ever further increased.

The second teeth 30a can be formed having flat flanks F that form a pyramid. However, as shown in FIG. 3, the second teeth 30a, in a non-limiting embodiment of the disclosure, have flanks formed having a convex curve contour F′ extending from a root to a peak, such that the convex contour of flanks F′ are tangent to the flat contour F at one point or more, thereby having a continuously varying thickness, also referred to as width W, wherein the width W varies in accordance with a non-linear, polynomial function. Accordingly, the opposite flanks of the second teeth 30a extending from the root to the peak have a non-flat contour.

The geometry of the flanks F′ of second teeth 30a is shown having a Gothic arch contour, which corresponds to the large dashed lines F′ that are tangent to the straight flanks F denoted by solid lines. A fillet radius R′ is needed at the top of the Gothic arch to eliminate establishing a sharp edge inherent to the intersection of the two arches or circles defining the Gothic arch. Similarly, a fillet root R is needed at the bottom of the Gothic arch to smoothly blend adjacent gothic arch contours F′. The Gothic arch allows larger root radii R than teeth formed merely as standard straight geometry serrations SG (FIGS. 6A and 6B), which facilitates manufacturing of the geometry disclosed herein and reduces stress concentrations at the bottom (root) of the second tooth 30a.

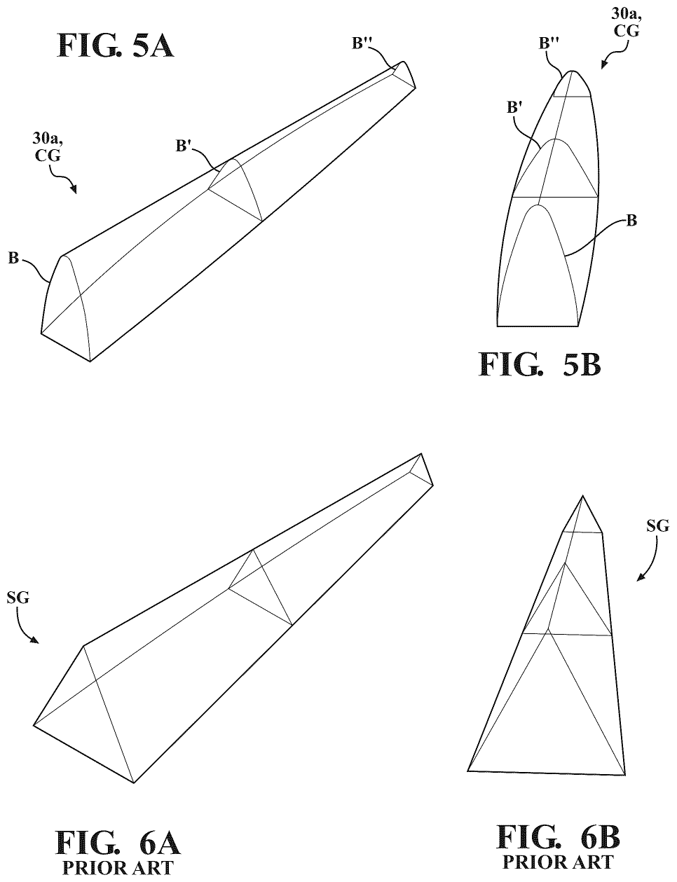

The wheel hub 12 first splined face 28 can have linearly straight, planar faced radially extending flank segments (FIGS. 6A and 6B), referred to as first teeth 28a, in contact with the convex, such as gothic arch, second teeth 30a (FIGS. 5A and 5B) on the CVJ 14, where the contact between the two sets of first and second teeth 28a, 30a, respectively, as a result of the second teeth 30a, occurs initially at only one contact point per plane B, B′, B″. As load is transferred or the CVJ 14 is secured to the wheel hub 12 by the tensioning bolt 22, slight deformation of second teeth 30a occurs and the contact point flattens slightly to become a contact line to broaden contact and support in comparison to a point, and also reduce the contact stresses between first and second teeth 28a, 30a. Another benefit of the convex tooth geometry of second teeth 30a is that the convex gothic arch provides inherent crowning to the tooth 30a. Therefore, concentrations of stress, known as edge contact, is avoided. It is to be understood that the contour of the second teeth 30a is not limited to a gothic arch contour. The same effect can be produced if an involute or cycloid geometries are used for the flank geometry. Polynomial or transcendent functions that generate a convex geometry, and at least one tangency point with the flank are contemplated herein.

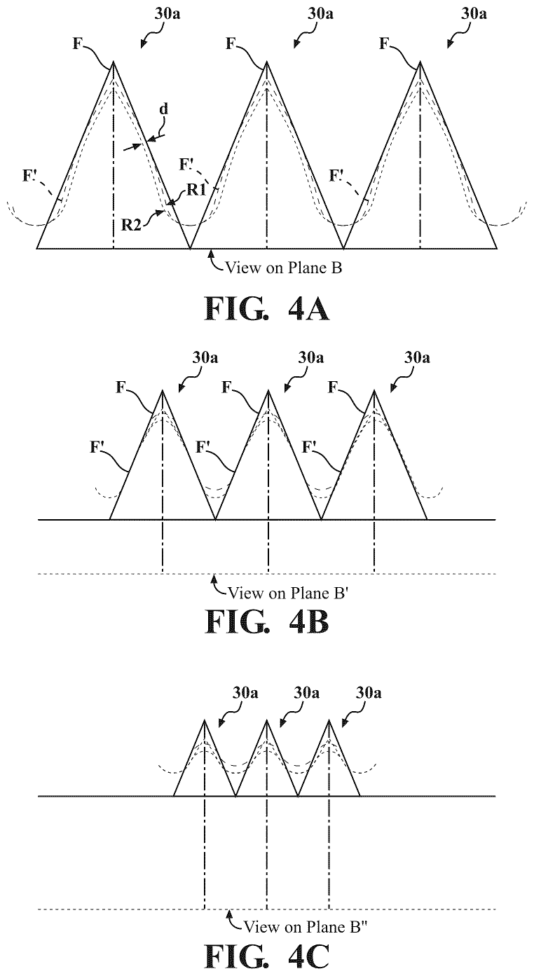

To further explain the benefit of defining the tooth geometry as being formed and varied over a series of planes spaced from one another, the cross sections along planes B, B′ and B″ are shown in FIGS. 4A, 4B, and 4C, respectively. In FIGS. 4A and 4B, planes B and B′, respectively, illustrate large dashed lines F′ defining the arched flank, such as a gothic arched flank F′, which is tangent to the flanks F of a standard linearly straight serration. During assembly of the splined face 30 having convex arch contoured flanks F′, the first point of contact during engagement occurs along Plane B′ (FIG. 4B) rather than radially outward Plane B (FIG. 4A), and thus, the first contact is not on the radial outside, outermost diameter of the splined faces 28, 30. This is accomplished by adding a small offset “d” to the gothic arch at plane B, which produces clearance between the standard straight serrations of first teeth 28a of the wheel hub 12 and the arcuate flanked second teeth 30a on the CVJ 14. The geometry with an offset is denoted by small dashed line (small dashes are shorter than the dashes of large dash line). Then as deformation occurs at plane B′, the clearance “d” is reduced until the contact occurs at plane B. It must be noted that the offset “d” is at one order of magnitude smaller than the magnitude of the radius (or curvature) defining the second teeth 30a on the CVJ 14.

r=R−d; where d<<R

The root fillet R2 when adding the offset d is larger than the root fillet R1 on the tangent Gothic arch geometry. This doesn't pose any negative effects on the manufacturing or state of stress of the second teeth 30a. The larger the blend, the easier to form and the lower the stress concentrations, thereby reducing cost of manufacture and increasing longevity of useful life.

R2>R1

FIGS. 5A-5B and 6A-6B show a comparison between a convex geometry CG, as taught and used in the present disclosure for second teeth 30a, and a standard, straight, planar faced serration geometry SG, not used in the present disclosure for second teeth 30a, but possibly used for the first teeth 28a. Of course, it is contemplated herein that the orientation/contours of the first and second teeth 28a, 30a could be reversed, such that the first teeth 28 are provided as shown and discussed for FIGS. 5A and 5B, and the second teeth 30a are provided as shown and discussed for FIGS. 6A and 6B. The dimensions and proportions have been exaggerated for visualization purposes only. The proportions of the figures have been exaggerated to highlight the wider section of the second tooth 30a at an intermediate, or mid-plane B′ located between the radial outer diameter or outer plane B and a radial inner extent, wherein the radial inner extent can be a radial inner diameter or inner plane B″, thereby providing a “crowning” effect when the tooth 30a is loaded, as discussed above.

Throughout this specification, the term “attach,” “attachment,” “connected”, “coupled,” “coupling,” “mount,” or “mounting” shall be interpreted to mean that a structural component or element is in some manner connected to or contacts another element, either directly or indirectly through at least one intervening structural element, or is integrally formed with the other structural element.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A constant velocity joint, comprising:
a first housing part having a pivotal bearing part and second housing part having a connection part, the connection part having an opening extending along a rotational axis of the first and second housing parts and having a splined face extending along a plane substantially transverse relation to the rotational axis, wherein the splined face has teeth extending from a radial inner diameter to a radial outer diameter, wherein the teeth are not the widest at the radial outer diameter.

2. The constant velocity joint of claim 1, wherein the teeth are not the widest at the radial inner diameter.

3. The constant velocity joint of claim 2, wherein the teeth are not defined by straight segments.

4. The constant velocity joint of claim 3, wherein the teeth are defined by connecting a series of 2D geometries defined on multiple planes extending between the radial inner diameter and the radial outer diameter.

5. The constant velocity joint of claim 4, wherein the 2D geometries are a continuous curve.

6. The constant velocity joint of claim 4, wherein the 2D geometries are 2nd order curves.

7. The constant velocity joint of claim 6, wherein the 2nd order curves are circles and/or ellipses.

8. The constant velocity joint of claim 4, wherein the 2D geometries are higher than 2nd order curves.

9. The constant velocity joint of claim 6, wherein the 2nd order curves are polynomials.

10. The constant velocity joint of claim 8, wherein the 2nd order curves are transcendent terms.

11. The constant velocity joint of claim 10, wherein the 2nd order curves are cycloids and/or involutes.

12. The constant velocity joint of claim 1, wherein the teeth are widest between the radial inner diameter and the radial outer diameter.

13. A constant velocity joint, comprising:
a first housing part having a pivotal bearing part and second housing part having a connection part, the connection part having a splined face extending along a plane substantially transverse relation to the rotational axis, wherein the splined face has teeth extending from a radial inner extent to a radial outer extent, wherein the teeth are widest at a location spaced radially from the radial inner extent and the radial outer extent.

14. The constant velocity joint of claim 13, wherein the teeth have opposite flanks extending from a root to a peak, wherein the opposite flanks have a non-flat contour extending from the root to the peak.

15. The constant velocity joint of claim 13, wherein the teeth are defined by connecting a series of 2D geometries defined on multiple planes extending between the radial inner extent and the radial outer extent.

16. The constant velocity joint of claim 15, wherein the 2D geometries are a continuous curve.

17. The constant velocity joint of claim 15, wherein the 2D geometries are 2nd order curves.

18. The constant velocity joint of claim 17, wherein the 2nd order curves are circles and/or ellipses.

19. The constant velocity joint of claim 17, wherein the 2nd order curves are polynomials.
